(19) United States
(12) Patent Application Publication
(10) Pub. No.: US 2014/0181687 A1
(43) Pub. Date: Jun. 26, 2014

(54) Method and Apparatus for Processing Contact Information

(71) Applicant: Huawei Technologies Co., Ltd., Shenzhen (CN)

(72) Inventors: Shuangxi Liu, Shenzhen (CN); Mengjun Fan, Hangzhou (CN); Dongxue Shi, Hangzhou (CN)

(73) Assignee: Huawei Technologies Co., Ltd., Shenzhen (CN)

(21) Appl. No.: 14/081,103

(22) Filed: Nov. 15, 2013

Related U.S. Application Data
(63) Continuation of application No. PCT/CN2013/080585, filed on Aug. 1, 2013.

(30) Foreign Application Priority Data
Dec. 25, 2012 (CN) 201210571726.1

(51) Int. Cl. H04L 12/58; G06F 3/0482

(52) U.S. Cl. CPC H04L 51/04; G06F 3/0482
USPC 715/752

(57) ABSTRACT

Embodiments of the present invention provide a method and an apparatus for processing contact information. The method includes: receiving an instant message from a peer end; determining whether the instant message includes a contact keyword related to local contact information; if the instant message includes a contact keyword related to local contact information, determining to prompt a user to send contact information corresponding to content of the instant message in the local contact information to the peer end. The method and the apparatus for processing contact information provided by the embodiments of the present invention can improve efficiency in processing contact information.

### CROSS-REFERENCE TO RELATED APPLICATIONS

This application is a continuation of International Application No. PCT/CN2013/080585, filed on Aug. 1, 2013, which claims priority to Chinese Patent Application No. 201210571726.1, filed on Dec. 25, 2012, both of which are hereby incorporated by reference in their entireties.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

Embodiments of the present invention relate to communications technologies, and in particular, to a method and an apparatus for processing contact information.

### BACKGROUND

With the development of communications technologies, implementing instant conversation by using a software terminal has become an important communication means among people. In a process of implementing instant conversation by a user terminal, such information processing processes as sending and storing contact information are usually involved.

In the prior art, in the process of implementing instant conversation by the user terminal, when the user terminal needs to send locally stored contact information to a peer end, the user terminal usually suspends the instant conversation and returns to a contact information list; through processes of copying, pasting, and even manually writing and entering contact information, the user terminal finally sends the contact information to the peer end. Similarly, during the instant conversation, when the user terminal receives contact information from the peer end, the user terminal also needs to suspend the instant conversation; through processes of copying, pasting, and even manually copying and entering the contact information, the user terminal stores the contact information sent by the peer end in a local contact information list.

Therefore, in the prior art, the process of processing contact information during instant communication is complex and inefficient.

### SUMMARY

Embodiments of the present invention provide a method and an apparatus for processing contact information to improve efficiency in processing contact information.

According to a first aspect, an embodiment of the present invention provides a method for processing contact information, including: receiving an instant message from a peer end; determining whether the instant message includes a contact keyword related to local contact information; and if the instant message includes a contact keyword related to local contact information, determining to prompt a user to send contact information corresponding to content of the instant message in the local contact information to the peer end.

In a first possible implementation manner of the first aspect, the contact keyword includes a contact name and/or a contact account.

In a second possible implementation manner of the first aspect, after the determining to prompt a user to send contact information corresponding to content of the instant message in the local contact information to the peer end, the method further includes: prompting the user with at least one operation associated with the contact keyword; receiving an operation command selected by the user according to the prompted operation; and sending the contact information to the peer end according to the operation command.

With reference to the first aspect or the second possible implementation manner of the first aspect, in a third possible implementation manner, the prompting the user with at least one operation associated with the contact keyword includes: displaying a function menu to the user, where the function menu includes at least a function option of sending contact information.

With reference to the first aspect or the second possible implementation manner of the first aspect or the third possible implementation manner of the first aspect, in a fourth possible implementation manner, before the prompting the user with at least one operation associated with the contact keyword, the method further includes: performing special display processing on the contact keyword; and receiving a click operation instruction performed by the user on the contact keyword that has undergone special display processing.

With reference to the first aspect or the first possible implementation manner of the first aspect or the second possible implementation manner of the first aspect or the third possible implementation manner of the first aspect or the fourth possible implementation manner of the first aspect, in a fifth possible implementation manner, after the sending contact information corresponding to content of the instant message in the local contact information to the peer end, the method further includes: displaying, in a display interface of the instant message, prompt information indicating that the contact information has already been sent.

According to a second aspect, an embodiment of the present invention provides an apparatus for processing contact information, including: a receiving module configured to receive an instant message from a peer end; a judging module configured to determine whether the instant message includes a contact keyword related to local contact information; and a determining module configured to determine to prompt a user to send contact information corresponding to content of the instant message in the local contact information to the peer end.

In a first possible implementation manner of the second aspect, the contact keyword includes a contact name and/or a contact account.

In a second possible implementation manner of the second aspect, the apparatus further includes a displaying module configured to prompt the user with at least one operation associated with the contact keyword.

The receiving module is further configured to receive an operation command selected by the user according to the prompted operation.

The apparatus further includes a sending module configured to send the contact information to the peer end according to the operation command.

With reference to the second aspect or the second possible implementation manner of the second aspect, in a third possible implementation manner, the displaying module is specifically configured to display a function menu to the user, where the function menu includes at least a function option of sending contact information.

With reference to the second aspect or the second possible implementation manner of the second aspect or the third possible implementation manner of the second aspect, in a fourth possible implementation manner, the displaying module is further configured to perform special display processing on the contact keyword before prompting the user with at least one operation associated with the contact keyword.

The receiving module is further configured to receive a click operation instruction performed by the user on the contact keyword that has undergone special display processing.

With reference to the second aspect or the first possible implementation manner of the second aspect or the second possible implementation manner of the second aspect or the third possible implementation manner of the second aspect or the fourth possible implementation manner of the second aspect, in a fifth possible implementation manner, the displaying module is further configured to: after the contact information in the local contact information and corresponding to the content of the instant message is sent to the peer end, display, in an display interface of the instant message, prompt information indicating that the contact information has already been sent.

In the technical solution provided by the embodiments of the present invention, during an instant message conversation, a user terminal identifies whether content of the instant message includes a contact keyword related to local contact information, compares the identified contact information with locally stored contact information, and quickly sends contact information corresponding to the content of the instant message in the local contact information to a peer end; when the user terminal receives contact information from the peer end during an instant message conversation, the user terminal can directly store the received contact information in a local contact information list, which improves efficiency in processing the contact information.

### BRIEF DESCRIPTION OF THE DRAWINGS

To describe the technical solutions in the embodiments of the present invention more clearly, the following briefly introduces the accompanying drawings required for describing the embodiments of the present invention. Apparently, the accompanying drawings in the following description show merely some embodiments of the present invention, and persons of ordinary skill in the art may still derive other drawings from these accompanying drawings without creative efforts.

FIG. 1 is a flowchart of Embodiment 1 of a method for processing contact information according to the present invention;

FIG. 2 is a schematic diagram of a contact keyword interface in the embodiment illustrated in FIG. 1;

FIG. 3 is a flowchart of Embodiment 2 of a method for processing contact information according to the present invention;

FIG. 4 is a schematic diagram of a prompt menu interface in the embodiment illustrated in FIG. 3;

FIG. 5 is a flowchart of Embodiment 3 of a method for processing contact information according to the present invention;

FIG. 6 is a schematic diagram of a vCard message interface in the embodiment illustrated in FIG. 5;

FIG. 7 is a flowchart of Embodiment 4 of a method for processing contact information according to the present invention;

FIG. 8 is a flowchart of Embodiment 5 of a method for processing contact information according to the present invention;

FIG. 9 is a flowchart of Embodiment 6 of a method for processing contact information according to the present invention;

FIG. 10 is a schematic structural diagram of Embodiment 1 of an apparatus for processing contact information according to the present invention;

FIG. 11 is a schematic structural diagram of Embodiment 2 of an apparatus for processing contact information according to the present invention; and

FIG. 12 is a schematic structural diagram of an embodiment of an intelligent terminal according to the present invention.

### DETAILED DESCRIPTION

To make the objectives, technical solutions, and advantages of the present invention more comprehensible, the following clearly describes the technical solutions in the embodiments of the present invention with reference to the accompanying drawings in the embodiments of the present invention. Apparently, the described embodiments are merely a part rather than all of the embodiments of the present invention. All other embodiments obtained by persons of ordinary skill in the art based on the embodiments of the present invention without creative efforts shall fall within the protection scope of the present invention.

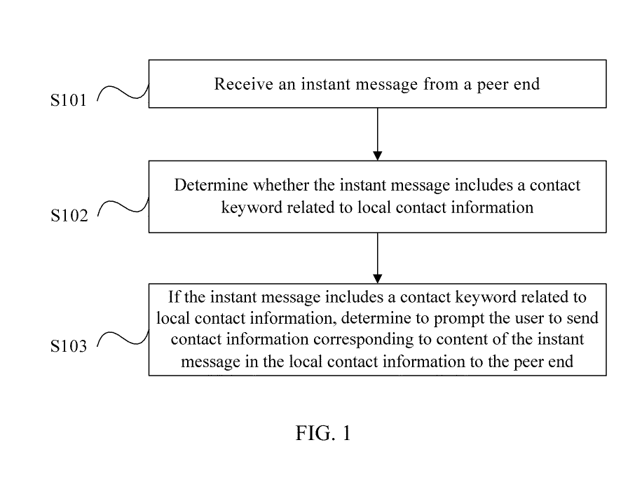

FIG. 1 is a flowchart of Embodiment 1 of a method for processing contact information according to the present invention. As shown in FIG. 1, the method in this embodiment may include the following steps:

S101: Receive an instant message from a peer end.

Specifically, users can implement an instant message conversation by using an instant communication software terminal. During the instant message conversation, a user terminal receives an instant message from a peer end.

S102: Determine whether the instant message includes a contact keyword related to local contact information.

Specifically, after the user terminal receives an instant message from the peer end, the user terminal can determine, by identifying and analyzing content of the instant message, whether contact information needs to be sent to the peer end. During the instant conversation between users, the content of the instant message may include such contact keywords as contact name, account, and telephone number. When receiving the instant message from the peer end, the user terminal automatically identifies the contact keyword in the content of the instant message, and compares the identified contact keyword with contact keywords in a contact database of a local software terminal, and further determines whether the contact database of the local software terminal includes the contact keyword involved in the content of the instant message.

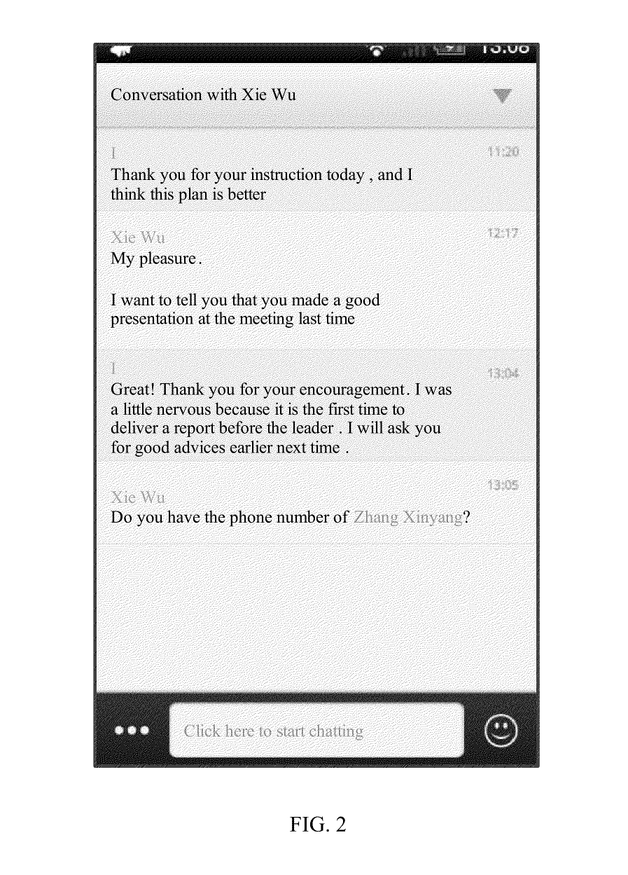

FIG. 2 is a schematic diagram of a contact keyword interface in the embodiment illustrated in FIG. 1. As shown in FIG. 2, the contact keyword may specifically include a contact name and/or a contact account.

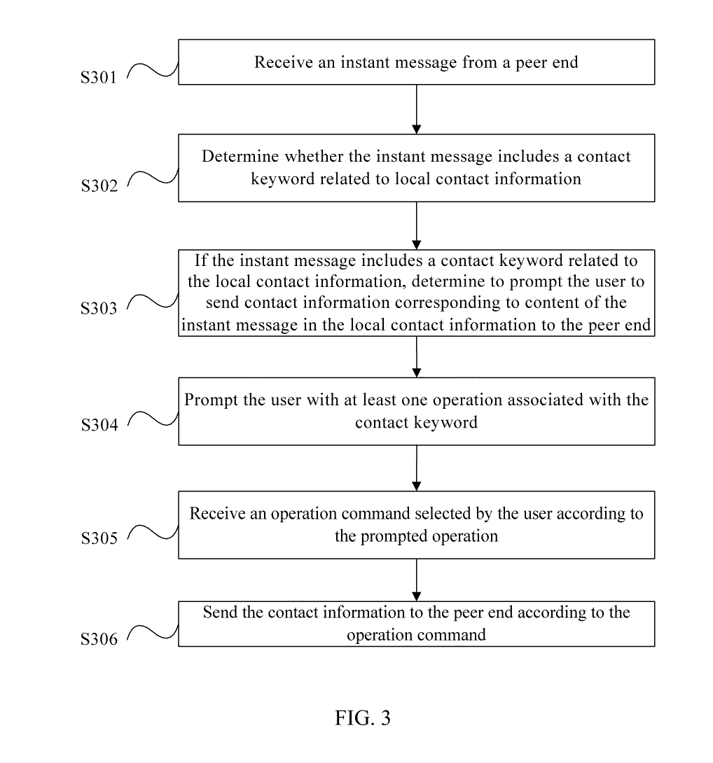

In specific applications, different types of contact keywords may be configured for different user objects and different application scenarios. During the instant message conversation, the user terminal identifies and determines the configured contact keyword, and displays the keyword to the user in a manner different from other words. For example, in FIG. 3, content of the instant message received by the user terminal includes a contact name “Zhang Xinyang”; the user terminal identifies the name keyword “Zhang Xinyang” in the instant message, and displays the identified keyword to the user in a color different from the color of other words.

S103: If the instant message includes a contact keyword related to local contact information, determine to prompt the user to send contact information corresponding to the content of the instant message in the local contact information to the peer end.

When the user terminal determines that the instant message includes the contact keyword related to the local contact information, the user terminal determines to prompt the user to send contact information corresponding to the content of the instant message in the local contact information to the peer end.

In this embodiment, during an instant message conversation, a user terminal identifies a contact information keyword included in the content of the instant message, and compares the identified contact information keyword with locally stored contact information keywords; when the user terminal determines that the instant message includes the contact keyword related to the local contact information, the user terminal determines to prompt a user to send contact information corresponding to the content of the instant message in the local contact information to a peer end. In this way, the contact information corresponding to the content of the instant message in the local contact information is quickly sent to other user terminals, which improves efficiency in processing the contact information.

FIG. 3 is a flowchart of Embodiment 2 of a method for processing contact information according to the present invention. As shown in FIG. 3, the method in this embodiment may include the following steps:

S301: Receive an instant message from a peer end.

Specifically, the execution method of S301 is similar to the execution method of S101 in the foregoing Embodiment 1 of the method for processing contact information, which is not further described herein.

S302: Determine whether the instant message includes a contact keyword related to local contact information.

Specifically, the execution method of S302 is similar to the execution method of S102 in the foregoing Embodiment 1 of the method for processing contact information, which is not further described herein.

S303: If the instant message includes a contact keyword related to local contact information, determine to prompt a user to send contact information corresponding to the content of the instant message in the local contact information to the peer end.

Specifically, the execution method of S303 is similar to the execution method of S103 in the foregoing Embodiment 1 of the method for processing contact information, which is not further described herein.

S304: Prompt the user with at least one operation associated with the contact keyword.

Specifically, after determining that a contact database of a local software terminal includes the contact information corresponding to the contact keyword included in the instant message, the user terminal prompts the user with at least one operation associated with the contact keyword, for example, initiating a session, making a call, and the like.

S305: Receive an operation command selected by the user according to the prompted operation.

The user terminal receives an operation command selected by the user.

S306: Send the contact information to the peer end according to the operation command.

Specifically, the user selects an operation command of sending the contact information corresponding to the content of the instant message in the local contact information to the peer end, and the user terminal sends the contact information to the peer end according to the operation command.

In this embodiment, after a user terminal determines that a contact database of a local software terminal includes contact information corresponding to a contact keyword included in the content of an instant message, the user terminal prompts a user with an operation associated with the contact keyword, which facilitates the user operation and improves efficiency in processing the contact information.

On the basis of Embodiment 3 of the method of the present invention illustrated in FIG. 3, the prompting the user with at least one operation associated with the contact keyword in S304 may specifically include: displaying a function menu to the user, where the function menu includes at least a function option of sending contact information.

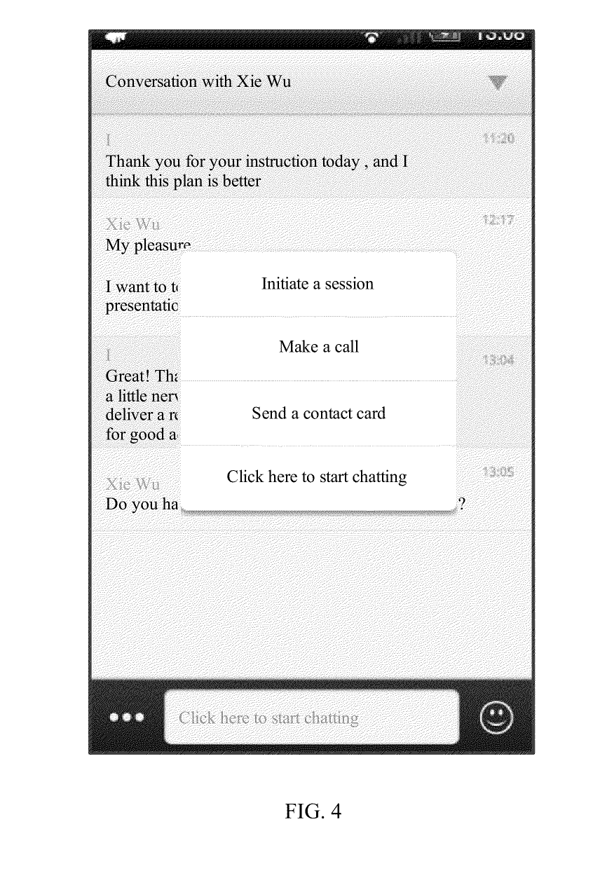

FIG. 4 is a schematic diagram of a prompt menu interface in the embodiment illustrated in FIG. 3. As shown in FIG. 4, in specific applications, different user function menus may be configured for a user with respect to different users and different application scenarios. For example, in FIG. 4, a function menu displayed to the user includes the following function options: initiating a session, making a call, and sending a vCard and detailed information, where the “sending a vCard” is a function option of sending contact information.

In this embodiment, after a user terminal determines that a contact database of a local software includes contact information corresponding to a contact keyword included in the content of an instant message, the user terminal prompts, by displaying a function menu to a user, the user with an operation associated with the contact keyword, where the function menu includes at least a function option of sending contact information, which improves the user's efficiency in sending the contact information.

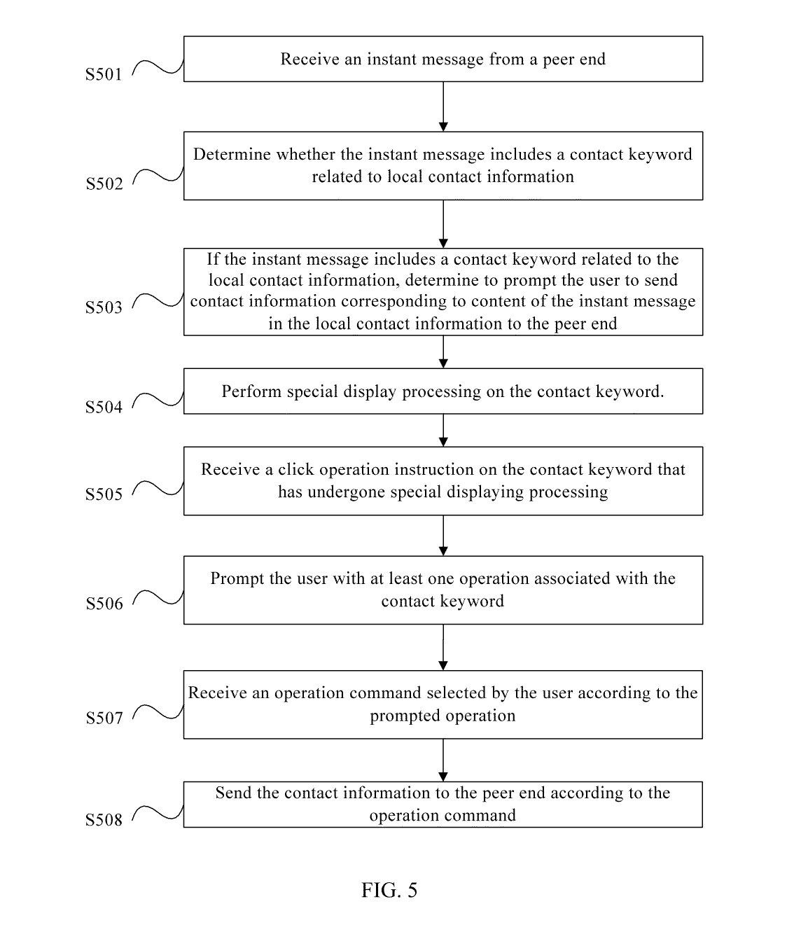

FIG. 5 is a flowchart of Embodiment 3 of a method for processing contact information according to the present invention. As shown in FIG. 5, the method in this embodiment may include the following steps:

S501: Receive an instant message from a peer end.

Specifically, the execution method of S501 is similar to the execution method of S101 in the foregoing Embodiment 1 of the method for processing contact information, which is not further described herein.

S502: Determine whether the instant message includes a contact keyword related to local contact information.

Specifically, the execution method of S502 is similar to the execution method of S102 in the foregoing Embodiment 1 of the method for processing contact information, which is not further described herein.

S503: If the instant message includes a contact keyword related to local contact information, determine to prompt the user to send contact information corresponding to the content of the instant message in the local contact information to the peer end.

Specifically, the execution method of S503 is similar to the execution method of S103 in the foregoing Embodiment 1 of the method for processing contact information, which is not further described herein.

S504: Perform special display processing on the contact keyword.

When the user terminal determines that a contact database of a local software terminal includes the contact information corresponding to the contact keyword included in the content of the instant message, the user terminal performs display processing such as highlighting and changing colors on the contact keyword, displays the contact keyword to the user in a manner different from other words, and sets the contact keyword to a clickable state.

S505: Receive a click operation instruction performed by the user on the contact keyword that has undergone special displaying processing.

The user terminal receives a click operation command performed by the user on the contact keyword that has undergone special display processing, where the click operation command of the user is viewing detailed information of the contact, sending a vCard, and calling the contact.

S506: Prompt the user with at least one operation associated with the contact keyword.

Specifically, the execution method of S506 is similar to the execution method of S304 in the foregoing Embodiment 2 of the method for processing contact information, which is not further described herein.

S507: Receive an operation command selected by the user according to the prompted operation.

Specifically, the execution method of S507 is similar to the execution method of S305 in the foregoing Embodiment 2 of the method for processing contact information, which is not further described herein.

S508: Send the contact information to the peer end according to the operation command.

Specifically, the execution method of S508 is similar to the execution method of S306 in the foregoing Embodiment 2 of the method for processing contact information, which is not further described herein.

In this embodiment, a user terminal performs special display processing on a contact keyword, and displays the contact keyword to a user in a manner different from other words, which helps the user select an operation and improves efficiency in processing the contact information.

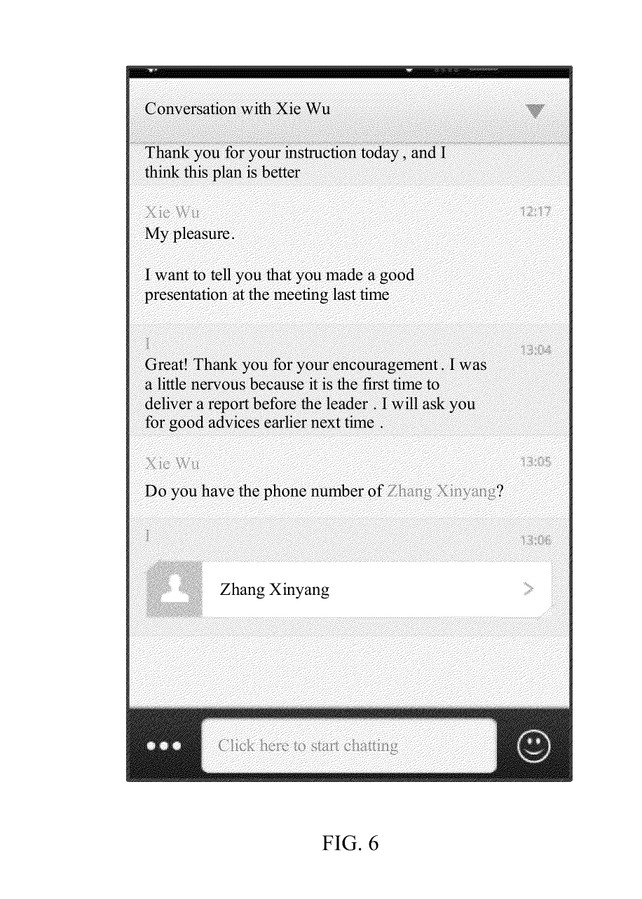

FIG. 6 is a schematic diagram of a vCard message interface in the embodiment illustrated in FIG. 5. As shown in FIG. 6, on the basis of all the foregoing embodiments, after the contact information corresponding to content of the instant message in the local contact information is sent to the peer end, prompt information indicating that the contact information has already been sent may also be displayed in a displaying interface of the instant message. For example, in FIG. 6, an instant message conversation window displays that a vCard message with a contact keyword “Zhang Xinyang” has been sent during a conversation between a user terminal and “Xie Wu”.

In this embodiment, prompt information indicating that a user terminal has already sent contact information is displayed in a displaying interface of an instant message, which helps a user search for a sending record or perform such operations as resending and improves efficiency in processing the contact information.

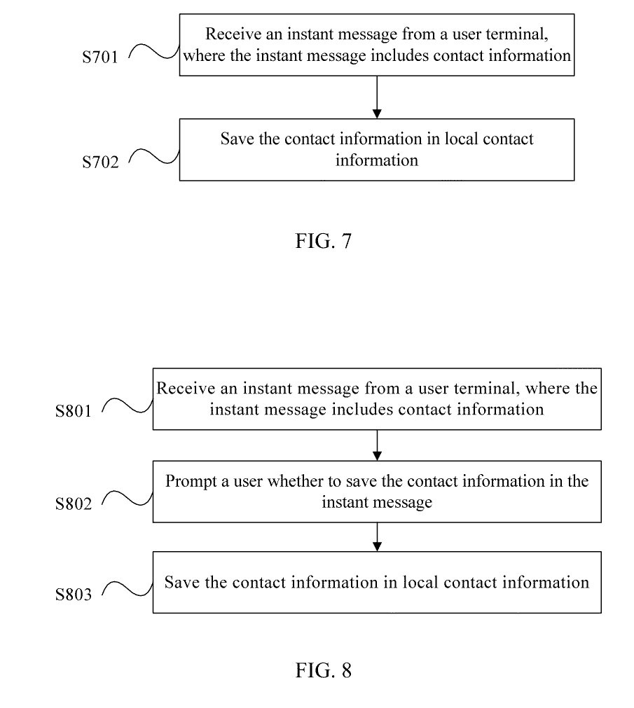

FIG. 7 is a flowchart of Embodiment 4 of a method for processing contact information according to the present invention. As shown in FIG. 7, the method in this embodiment may include the following steps:

S701: Receive an instant message from a user terminal, where the instant message includes contact information.

Specifically, during an instant message communication between a peer end and a user terminal, an instant message is received from the user terminal, where the instant message includes contact information.

S702: Save the contact information in local contact information.

Specifically, when the peer end receives the instant message from the user terminal and determines that the instant message includes the contact information, the peer end can save the contact information in the local contact information. For example, the user terminal sends the contact information in the form of a vCard to the peer end, where the vCard includes all information about the contact; when receiving the vCard information, the peer end can save the vCard in the local contact information as a whole.

In this embodiment, during an instant message conversation, a user terminal receives an instant message that includes contact information from another user terminal, and saves the contact information in local contact information, which implements fast storage of the contact information and improves efficiency in processing the contact information.

FIG. 8 is a flowchart of Embodiment 5 of a method for processing contact information according to the present invention. As shown in FIG. 8, the method in this embodiment may include the following steps:

S801: Receive an instant message from a user terminal, where the instant message includes contact information.

Specifically, the execution method of S801 is similar to the execution method of S701 in the foregoing Embodiment 4 of the method for processing contact information, which is not further described herein.

S802: Prompt a user whether to save the contact information in the instant message.

Specifically, when a peer end receives the instant message from the user terminal and determines that the instant message includes the contact information, the peer end can prompt, by showing a prompt message, the user to view details of the contact information, or save the contact information in local contact information, or give up saving the contact information.

S803: Save the contact information in the local contact information.

Specifically, the execution method of S803 is similar to the execution method of S702 in the foregoing Embodiment 4 of the method for processing contact information, which is not further described herein.

In this embodiment, after a user terminal receives an instant message that includes contact information, the user terminal prompts a user to perform a related operation on the contact information in the instant message; by referring to the prompt information, the user can quickly process the contact information by performing only a simple confirmation operation, which improves efficiency in processing the contact information.

FIG. 9 is a flowchart of Embodiment 6 of a method for processing contact information according to the present invention. As shown in FIG. 9, on the basis of Embodiment 1 of the method of the present invention illustrated in FIG. 1 and Embodiment 7 of the method of the present invention illustrated in FIG. 7, the method in this embodiment may include the following steps:

S901: Send an instant message to query a phone number of C.

Specifically, a first user sends an instant message by using a first terminal to query a phone number of C, and the first terminal sends the instant message to an instant messaging server.

S902: Forward the instant message.

The instant messaging server forwards the instant message to a second terminal.

S903: Identify that content of the instant message includes a contact keyword, and automatically query local contact information.

When the second terminal receives the instant message from the first terminal, the second terminal automatically identifies a contact keyword included in the content of the instant message, compares the identified contact keyword with contact keywords in a contact database of a local software terminal, and further determines whether the contact database of the local software terminal includes the contact information involved in the content of the instant message. The contact keyword in this embodiment is the contact name “C”.

S904: Display the contact keyword in a different manner.

When the second terminal determines that the contact database of the local software terminal includes the contact information corresponding to the contact keyword included in the content of the instant message, the second terminal performs display processing such as highlighting and changing colors on the contact keyword, displays the contact keyword to the user in a manner different from other words, and sets the contact keyword to a clickable state.

S905: The user clicks the contact keyword displayed in a different manner.

A second user clicks the contact keyword displayed in a different manner.

S906: Display a function menu to the user.

The second terminal displays a function menu to the user, where the function menu includes a function option of sending contact information.

S907: The user selects the function option of sending contact information.

The second user selects, by clicking the corresponding option of sending contact information from the function menu, the function option of sending contact information.

S908: Send a vCard message.

The second terminal sends, by sending a vCard message, the contact information to the instant messaging server as a whole.

S909: Forward the vCard message.

The instant messaging server forwards the vCard message sent by the second terminal to the first terminal.

S910: Prompt the user whether to save the contact information locally.

After the first terminal receives the instant message forwarded by the instant messaging server and determines that the instant message is a vCard message, the first terminal prompts the user whether to save the contact information in the local contact information.

S911: The user clicks “Save”.

By referring to the prompt information, the first user clicks “Save” to save the contact information in the local contact information.

S912: Save the vCard information in the local contact database.

The first terminal saves the received vCard information in the local contact database as a whole.

In this embodiment, during an instant message conversation, a user terminal identifies contact information included in the content of an instant message, compares the identified contact information with locally stored contact information, and quickly sends contact information corresponding to the content of the instant message in the local contact information to a peer end; when the user terminal receives contact information from the peer end during the instant message conversation, the user terminal can directly save the received contact information in a local contact information list, which improves efficiency in processing the contact information.

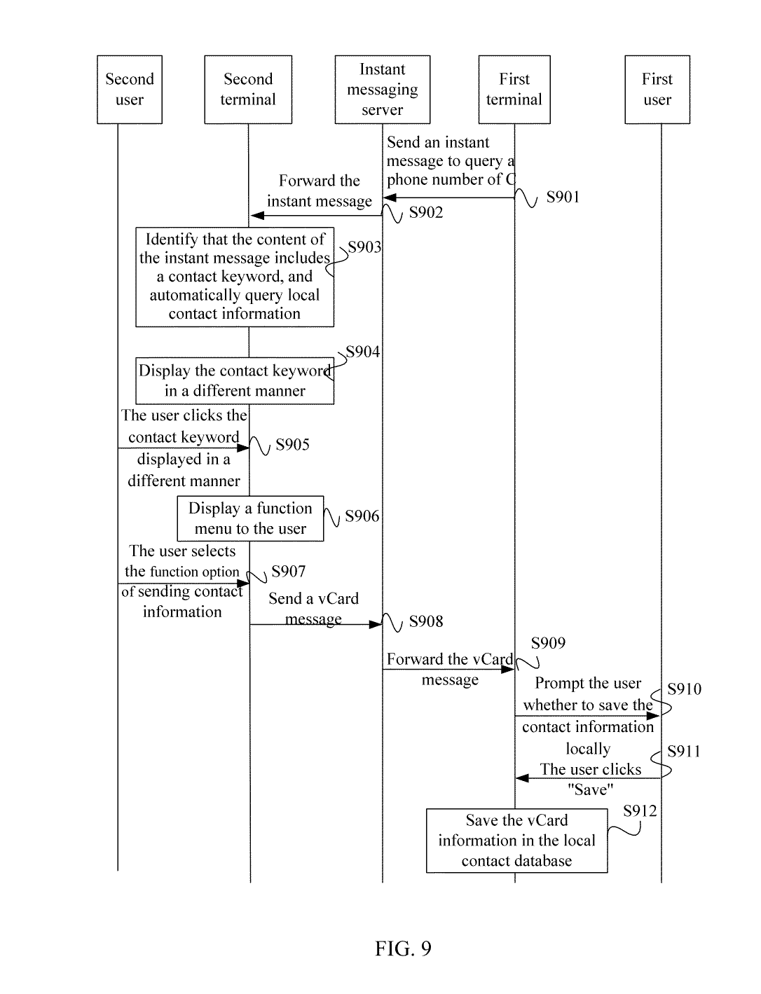

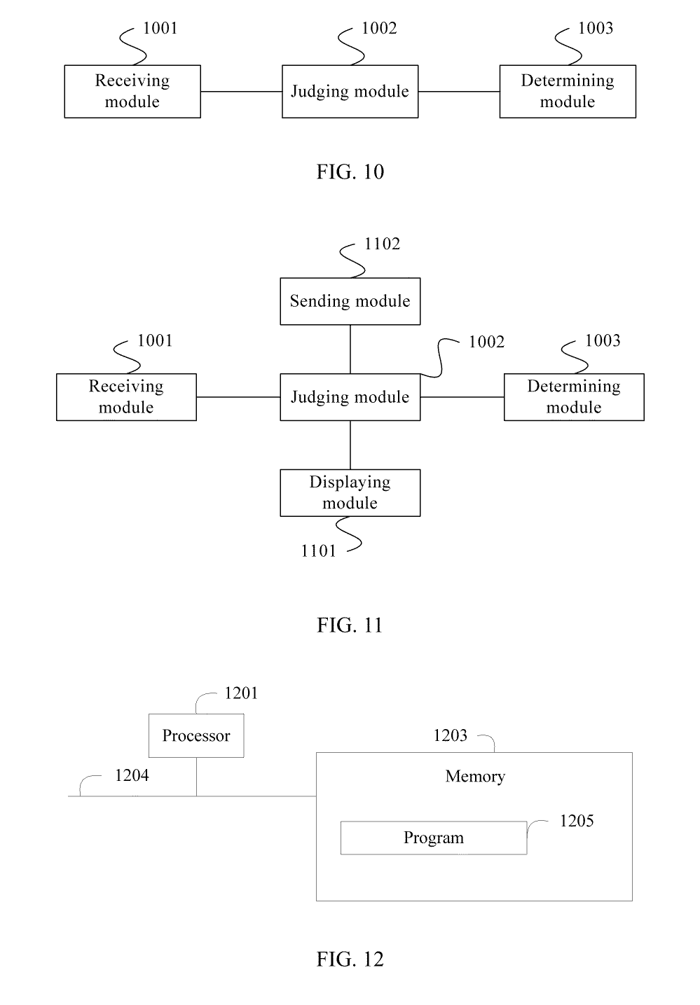

FIG. 10 is a schematic structural diagram of Embodiment 1 of an apparatus for processing contact information according to the present invention. As shown in FIG. 10, the apparatus in this embodiment may include a receiving module 1001, a judging module 1002, and a determining module 1003. The receiving module 1001 is configured to receive an instant message from a peer end. The judging module 1002 is configured to determine whether the instant message includes a contact keyword related to local contact information. The determining module 1003 is configured to determine to prompt a user to send contact information corresponding to the content of the instant message in the local contact information to the peer end.

The apparatus for processing contact information provided in this embodiment can be configured to execute the method in the method embodiment illustrated in FIG. 1. The implementation principle and desired technical effect of the apparatus are similar to those of the method embodiment, which are not further described herein.

In the foregoing apparatus for processing contact information, preferably, the contact keyword is a contact name and/or a contact account.

The implementation principle and desired technical effect of the apparatus for processing contact information in this embodiment have been described in the foregoing embodiments, which are not further described herein.

FIG. 11 is a schematic structural diagram of Embodiment 2 of an apparatus for processing contact information according to the present invention. As shown in FIG. 11, the apparatus in this embodiment may further include: a displaying module 1101 configured to prompt a user with at least one operation associated with a contact keyword; the receiving module 1001, further configured to receive an operation command selected by the user according to the prompted operation; and a sending module 1102 configured to send the contact information to a first terminal according to the operation command.

The apparatus for processing contact information provided in this embodiment can be configured to execute the method in the method embodiment illustrated in FIG. 3. The implementation principle and desired technical effect of the apparatus are similar to those of the method embodiment, which are not further described herein.

In the foregoing apparatus for processing contact information, the displaying module 1101 may be specifically configured to display a function menu to the user, where the function menu includes at least a function option of sending contact information.

The implementation principle and desired technical effect of the apparatus for processing contact information in this embodiment have been described in the foregoing embodiments, which are not further described herein.

In the foregoing apparatus for processing contact information, the displaying module 1101 may be further configured to: before prompting the user with at least one operation associated with the contact keyword, perform special display processing on the contact keyword; and the receiving module 1001 may be further configured to receive a click operation instruction performed by the user on the contact keyword that has undergone special display processing.

The apparatus for processing contact information provided in this embodiment can be configured to execute the method in the method embodiment illustrated in FIG. 5. The implementation principle and desired technical effect of the apparatus are similar to those of the method embodiment, which are not further described herein.

In the foregoing apparatus for processing contact information, the displaying module 1101 may be further configured to: after the sending module 1102 sends the contact information corresponding to the content of the instant message in the local contact information to the first terminal, display, in a displaying interface of the instant message, prompt information indicating that the contact information has already been sent.

The implementation principle and desired technical effect of the apparatus for processing contact information in this embodiment have been described in the foregoing embodiments, which are not further described herein.

FIG. 12 is a schematic structural diagram of an intelligent terminal embodiment according to the present invention. As shown in FIG. 12, the intelligent terminal includes at least one processor 1201 (for example, a central processing unit (CPU)), a memory 1203, and at least one communications bus 1204 configured to implement connection communication between devices. The processor 1201 is configured to execute executable modules, for example, a computer program, stored in the memory 1203. The memory 1203 may include a high speed random access memory (RAM), and may also include a non-volatile memory, for example, at least one magnetic disk memory.

In some implementation manners, the memory 1203 stores a program 1205, where the program 1205 can be executed by the processor 1201 and the program includes executing a method for processing contact information. The method includes: receiving an instant message from a peer end; determining whether the instant message includes a contact keyword related to local contact information; and if the instant message includes a contact keyword related to local contact information, determining to prompt a user to send contact information corresponding to content of the instant message in the local contact information to the peer end.

In the foregoing program that executes the method for processing contact information, preferably, the contact keyword includes a contact name and/or a contact account.

In the foregoing program that executes the method for processing contact information, preferably, after the determining to prompt a user to send contact information corresponding to the content of the instant message in the local contact information to the peer end, the program further includes: prompting the user with at least one operation associated with the contact keyword; receiving an operation command selected by the user according to the prompted operation; and sending the contact information to the peer end according to the operation command.

In the foregoing program that executes the method for processing contact information, preferably, the prompting the user with at least one operation associated with the contact keyword includes: displaying a function menu to the user, where the function menu includes at least a function option of sending contact information.

In the foregoing program that executes the method for processing contact information, preferably, before the prompting the user with at least one operation associated with the contact keyword, the program further includes: performing special displaying processing on the contact keyword; and receiving a click operation instruction performed by the user on the contact keyword that has been performed special displaying processing.

In the foregoing program that executes the method for processing contact information, preferably, after the sending the contact information corresponding to the content of the instant message in the local contact information to the peer end, the program further includes: displaying, in a displaying interface of the instant message, prompt information indicating that the contact information has already been sent.

Persons of ordinary skill in the art may understand that, all or a part of the steps of the foregoing method embodiments may be implemented by a program instructing related hardware. The foregoing program may be stored in a computer readable storage medium. When the program runs, the steps of the foregoing method embodiments are performed. The foregoing storage medium includes various mediums capable of storing program code, such as a read-only memory (ROM), a RAM, a magnetic disc, or an optical disc.

Finally, it should be noted that the foregoing embodiments are merely intended for describing the technical solutions of the present invention other than limiting the present invention. Although the present invention is described in detail with reference to the foregoing embodiments, persons of ordinary skill in the art should understand that they may still make modifications to the technical solutions described in the foregoing embodiments, or make equivalent replacements to some or all the technical features thereof, without departing from the spirit and scope of the technical solutions of the embodiments of the present invention.

What is claimed is:

1. A method for processing contact information, comprising:
receiving an instant message from a peer end;
determining whether the instant message comprises a contact keyword related to local contact information; and
determining to prompt a user to send contact information corresponding to content of the instant message in the local contact information to the peer end when the instant message comprises a contact keyword related to the local contact information.

2. The method according to claim 1, wherein the contact keyword comprises a contact name and/or a contact account.

3. The method according to claim 1, wherein after determining to prompt the user to send the contact information corresponding to the content of the instant message in the local contact information to the peer end, the method further comprises:
prompting the user with at least one operation associated with the contact keyword;
receiving an operation command selected by the user according to the prompted operation; and
sending the contact information to the peer end according to the operation command.

4. The method according to claim 3, wherein prompting the user with the at least one operation associated with the contact keyword comprises displaying a function menu to the user, wherein the function menu comprises at least a function option of sending contact information.

5. The method according to claim 3, wherein before prompting the user with the at least one operation associated with the contact keyword, the method further comprises:
performing special display processing on the contact keyword; and
receiving a click operation instruction performed by the user on the contact keyword that has undergone special display processing.

6. The method according to claim 1, wherein after sending the contact information corresponding to the content of the instant message in the local contact information to the peer end, the method further comprises displaying, in a displaying interface of the instant message, prompt information indicating that the contact information has already been sent.

7. An apparatus for processing contact information, comprising:
a receiving module configured to receive an instant message from a peer end;
a judging module configured to determine whether the instant message comprises a contact keyword related to local contact information; and
a determining module configured to determine to prompt a user to send contact information corresponding to content of the instant message in the local contact information to the peer end.

8. The apparatus according to claim 7, wherein the contact keyword comprises a contact name and/or a contact account.

9. The apparatus according to claim 7, further comprising a displaying module configured to prompt the user with at least one operation associated with the contact keyword, wherein the receiving module is further configured to receive an operation command selected by the user according to the prompted operation, and wherein the apparatus further comprises a sending module configured to send the contact information to the peer end according to the operation command.

10. The apparatus according to claim 9, wherein the displaying module is specifically configured to display a function menu to the user, and wherein the function menu comprises at least a function option of sending contact information.

11. The apparatus according to claim 9, wherein the displaying module is further configured to perform special display processing on the contact keyword before prompting the user with at least one operation associated with the contact keyword, and wherein the receiving module is further configured to receive a click operation instruction performed by the user on the contact keyword that has undergone special display processing.

12. The apparatus according to claim 7, wherein the displaying module is further configured to display, in a displaying interface of the instant message, prompt information indicating that the contact information has already been sent after the contact information in the local contact information and corresponding to the content of the instant message is sent to the peer end.

13. A non-transitory computer-readable medium having computer usable instructions stored thereon for execution by a processor, wherein the instructions cause the processor to:
receive an instant message from a peer end;
determine whether the instant message comprises a contact keyword related to local contact information; and
determine to prompt a user to send contact information corresponding to content of the instant message in the local contact information to the peer end when the instant message comprises a contact keyword related to the local contact information.

14. The non-transitory computer-readable medium of claim 13, wherein the contact keyword comprises a contact name.

15. The non-transitory computer-readable medium of claim 13, wherein the contact keyword comprises a contact account.

16. The non-transitory computer-readable medium of claim 13, wherein the instructions are further configured to cause the processor to:
prompt the user with at least one operation associated with the contact keyword;
receive an operation command selected by the user according to the prompted operation; and
send the contact information to the peer end according to the operation command.

17. The non-transitory computer-readable medium of claim 16, wherein the instructions are configured to cause the processor to prompt the user with the at least one operation associated with the contact keyword comprises the instructions causing the processor to display a function menu to the user, wherein the function menu comprises at least a function option of sending contact information.

18. The non-transitory computer-readable medium of claim 13, wherein the instructions are further configured to cause the processor to:
perform special display processing on the contact keyword; and
receive a click operation instruction performed by the user on the contact keyword that has undergone special display processing.

19. The non-transitory computer-readable medium of claim 13, wherein the instructions are further configured to cause the processor to display, in a displaying interface of the instant message, prompt information.

20. The non-transitory computer-readable medium of claim 19, wherein the prompt information indicates that the contact information has already been sent.
